(19) United States
(12) Patent Application Publication
(10) Pub. No.: US 2022/0197623 A1
(43) Pub. Date: Jun. 23, 2022

(54) APPLICATION PRESENCE MONITORING AND REINSTILLATION

(71) Applicant: Hewlett-Packard Development Company, L.P., Spring, TX (US)

(72) Inventors: Endrigo Nadin Pinheiro, Spring, TX (US); Richard Bramley, Mansfield, MA (US); Valiuddin Ali, Spring, TX (US)

(73) Assignee: Hewlett-Packard Development Company, L.P., Spring, TX (US)

(21) Appl. No.: 17/297,131

(22) PCT Filed: Sep. 12, 2019
(86) PCT No.: PCT/US2019/050770

§ 371 Date: May 26, 2021

(51) Int. Cl. G06F 8/61

(52) U.S. Cl. CPC G06F 8/61

(57) ABSTRACT

In an example, a non-transitory computer-readable medium has instructions stored therein that, in response to being executed on computer circuitry, cause the computer circuitry to execute instructions to operate an application installed in the memory circuitry and to generate an iterative communication to indicate that the application is operating. The instructions further cause, in response to being executed, the computer circuitry to detect the presence of the iterative communication, and to reinstall the application in response to an interruption in the iterative communication.

### BACKGROUND

Persisting applications in a computer environment can be challenging. For instance, applications may inadvertently stop running due to operational issues. In addition, rogue applications and scripts may prevent a process from running, without user intervention. This can cause problems such as lack of compliance with centralized managed systems, and security breaches caused by non-working firewalls or antivirus.

### BRIEF DESCRIPTION OF FIGURES

Various examples may be more completely understood in consideration of the following detailed description in connection with the accompanying drawings, in which:

FIG. 1 is a diagram illustrating an example apparatus involving application presence monitoring and reinstallation, in accordance with the present disclosure;

FIG. 2 is a diagram illustrating an example data flow diagram involving monitoring and reinstalling applications, and which may be implemented as a non-transitory computer readable medium (CRM) with stored instructions, in accordance with the present disclosure;

FIG. 3 is a diagram illustrating an example non-transitory CRM with stored instructions for reinstalling applications based on iterative communications, in accordance with the present disclosure;

FIG. 4 is a diagram illustrating an example non-transitory CRM with stored instructions for reinstalling applications that have terminated, in accordance with the present disclosure; and

FIG. 5 is a diagram illustrating an example non-transitory CRM with stored instructions for monitoring application operation and reinitiating applications that have ceased operation, in accordance with the present disclosure.

### DETAILED DESCRIPTION

Aspects of the present disclosure are directed to addressing issues relating to ensuring that certain applications continue to operate. Particular aspects are directed to apparatuses and methods involving the use of hardware to enforce the execution of applications running in an operating system, by generating iterative communications via the applications and re-injecting applications that cease to generate the iterative communications.

In accordance with a particular example, a non-transitory computer-readable medium has instructions stored therein that, in response to being executed on computer circuitry, cause the computer circuitry to execute instructions to operate an application installed in the memory circuitry, and to generate an iterative communication to indicate that the application is operating. The instructions further cause the computer circuitry to detect the presence of the iterative communication, and to reinstall the application in response to an interruption in the iterative communication.

Another example is directed to a non-transitory computer-readable medium having instructions stored therein that, in response to being executed on computer circuitry, cause the computer circuitry to generate an iterative communication to indicate that a plurality of applications are being executed. The iterative communications generated for each of the plurality of applications are monitored. Termination of one of the applications is identified based on persistence characteristics of the iterative communications, and the one of the applications is reinstalled in response to identifying that one of the applications has terminated operation.

Another example is directed to a non-transitory computer-readable medium having instructions stored therein that cause, in response to being executed on computer circuitry, the computer circuitry to generate a detectable communication that identifies an application installed in the memory and that indicates that the application is operating. Based on the generation of the detectable communication, the instructions cause the computer circuitry to determine whether the application is operating, and to reinitiate operation of the application in response to determining that the application is inactive.

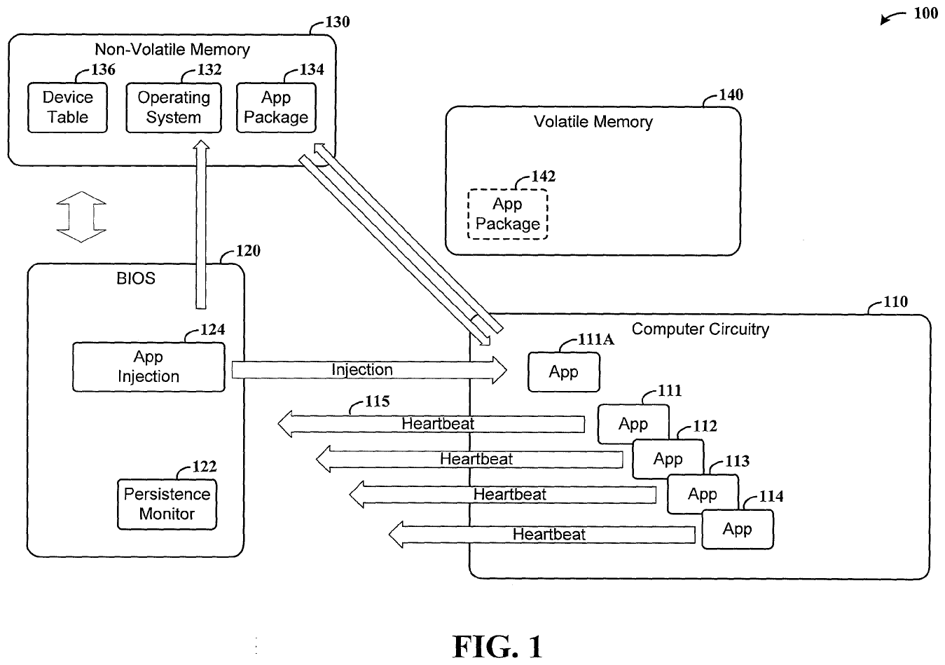

Turning now to the figures, FIG. 1 is a diagram illustrating an example apparatus 100 involving application presence monitoring and reinstallation, in accordance with the present disclosure. The apparatus 100 includes computer circuitry 110, a BIOS (basic input/output system) or UEFI (unified extensible firmware interface) block 120, non-volatile memory 130 and volatile memory 140. The computer circuitry 110 may be implemented as, for example, a central processing unit (CPU) or other logic circuitry to execute instructions for carrying out operations, and which may interface with input/output circuitry and the non-volatile memory 130 and volatile memory 140. The BIOS or UEFI block 120 may, for example, be implemented within the computer circuitry 110, such as by using circuitry therein to execute instructions stored in the non-volatile memory 130. Further, one or both of the non-volatile memory 130 and volatile memory 140 may be implemented in a common set of circuitry with the computer circuitry 110.

The computer circuitry 110 operates according to an operating system, as may be implemented with operating system block 132 stored in the non-volatile memory. The non-volatile memory may further store application package data 134, which may include information for installing an application or many applications. The non-volatile memory 130 may further include a device table 136, in which devices operated by the computer circuitry 110 are registered. Such devices may include, for example, monitors, printers, print spoolers, graphics cards, and a multitude of other computer components.

The computer circuitry 110 may operate a plurality of different applications for carrying out a variety of functions. By way of example, applications 111, 112, 113 and 114 are shown, the operation of which involves an intended function such as performing antivirus aspects, as well as generating an iterative communication (or “heartbeat”), which indicates that the application is functioning. The BIOS or UEFI block 120 includes a persistence monitor block 122 that monitors the applications 111-114 for detecting the presence of an iterative communication from each application. This approach may involve, for example, monitoring on a cyclic basis, with the applications programmed to generate the iterative communications on a corresponding cycle. When the persistence monitor block 122 detects that one of the applications has not communicated an iterative communication as expected, an application injection block 124 reinstalls the application as characterized herein.

Monitoring and reinstallation of applications may be carried out in a variety of manners. In one example, when computer circuitry 110 starts up, application 111 may be started as well. Once operating, application 111 generates an iterative communication 115 that is monitored by the persistence monitor block 122. If the application 111 fails or is maliciously terminated, it no longer generates the iterative communication 115. The persistence monitor block 122 detects that the application 111 is no longer generating the iterative communication, the application injection block 124 ensures that the application is reinstalled, represented by application 111A.

Reinstallation or injection of an application that has terminated may be carried out in a variety of manners. In a specific example, the application package data 134 includes information sufficient for installing an application. This information may include a script and other data utilized in reinstalling an application that has been removed or that has crashed. The device table 136 is updated with device ID data for one of the applications that maps to a certain package in the application package data 134 for the particular application. When the persistence monitor block 122 detects that the particular application is not generating its iterative communication, the application injection block 124 generates a communication that is interpreted by the operating system (carried out via the computer circuitry 110) as an indication that the device having the device ID is present. The operating system is responsive by accessing the corresponding package data to which the device ID is mapped, and executes the package data as if a driver for the device (now indicated as being present) is being installed. For instance, this may involve running a script that causes application 111A to be injected for operating again via the computer circuitry 110.

In certain examples, the application injection module may access and install an application directly, in response to the application's iterative communication failing to be detected. For instance, stored data in the non-volatile memory 130 or (142) in the volatile memory 140 can be accessed and operated directly.

Blocks as depicted in FIG. 1 may connote structure, such as circuits or circuitry selected or designed to carry out specific acts or functions. Whether alone or in combination with other such blocks or circuitry that may include discrete circuit elements, these blocks may be circuits coded by fixed design and/or by configurable circuitry and/or circuit elements for carrying out such operational aspects. For instance, configurable computer circuitry may include memory circuitry for storing and accessing a set of program code to be accessed/executed as instructions and/or configuration data to perform the related operation.

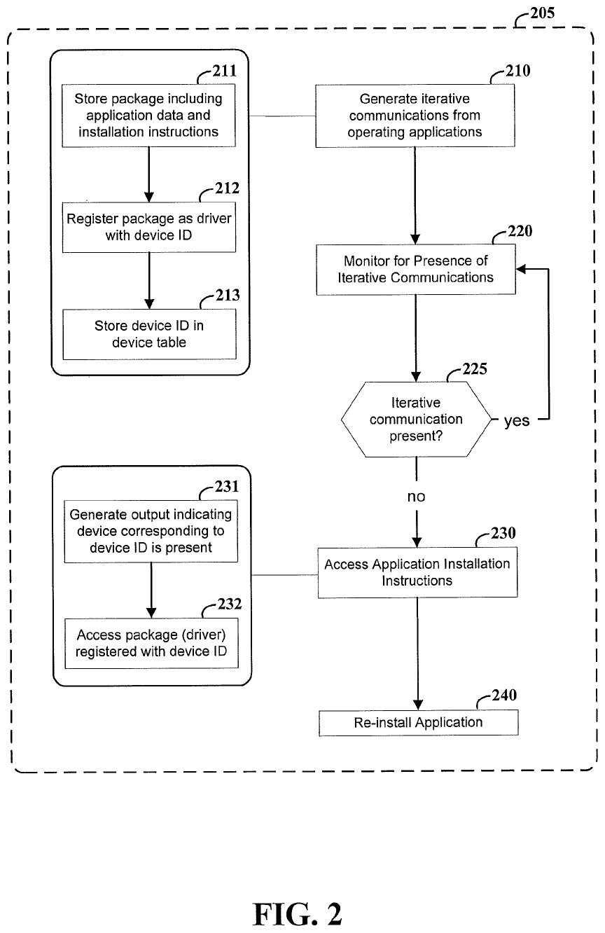

FIG. 2 is a diagram illustrating an example data flow, as may be implemented in accordance with the present disclosure. In some examples, the data may be implemented as instructions stored on a non-transitory CRM 205, which carry out the indicated functions upon execution. At block 210, iterative communications are generated from applications operating on a computer device. The presence of the iterative communications is monitored at block 220. If iterative communications are present as expected at block 225, the monitoring continues at block 220. If iterative communications are interrupted or otherwise not present at block 225 as expected, application installation instructions are accessed at block 230, and the application is re-installed at block 240.

In some implementations, further operations are carried out as follows. At block 211, a package including application data and application installation instructions are stored for an application to be persisted. The package is registered as a driver with a device ID at block 212, and the device ID is stored in a device table at 213. This information may then be used to reinstall the application corresponding to the package. For instance, in certain implementations, accessing the application instructions and the related reinstallation at blocks 230 and 240 are carried out with additional operations as follows. At block 231, an output is generated, which indicates that a device corresponding to a particular device ID is present. This output causes the corresponding package (registered as a driver for the device ID) to be accessed at block 232. This may, for example, involve causing a computer operating system to automatically look for a driver for serving a newly-presented device, mapping to the packaged registered as a driver at block 212, and executing a script in the package that causes reinstallation of the application.

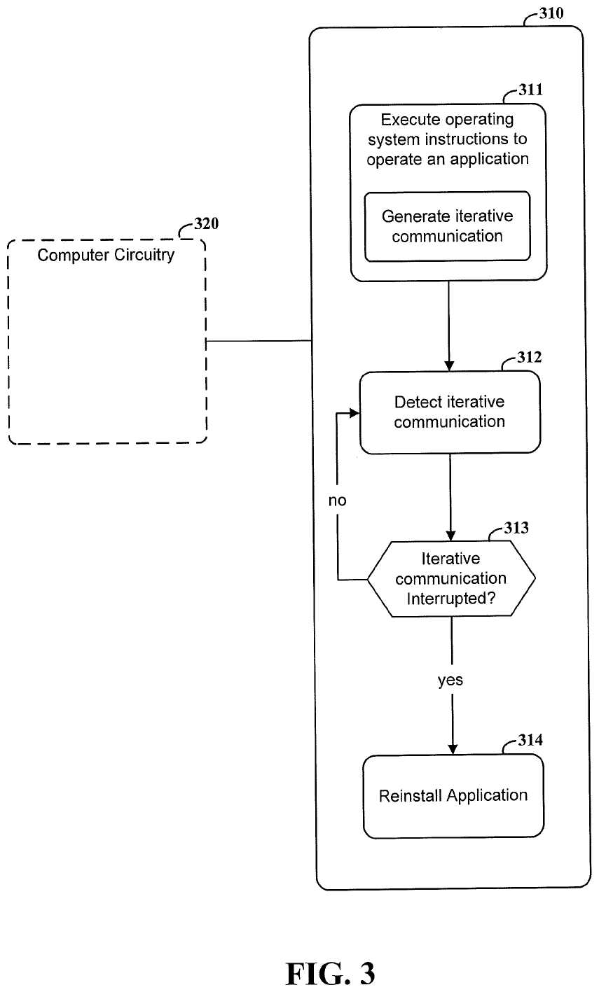

FIG. 3 is a diagram illustrating an example non-transitory CRM 310 with stored instructions for reinstalling applications based on iterative communications, in accordance with the present disclosure. By way of example, computer circuitry 320, such as a CPU, is shown in dashed lines and may be implemented with or include the CRM 310, by executing instructions within the non-transitory CRM for carrying out operations noted in the respective blocks therein. At block 311, operating system (OS) instructions are executed to operate an application, which includes generating an iterative communication. At block 312, iterative communications from the application are detected. If the iterative communication is interrupted at block 313, the application is reinstalled at block 314. If the iterative communication is not interrupted at block 313, further iterative communications are detected at block 312.

In some examples, the iterative communication generated at block 311 is a heartbeat-type communication generated on repeated basis when the application is running. Termination of such a heartbeat-type communication is indicative that the application is no longer running. The iterative communication may include, for example, data that identifies the application installed in memory. The CRM 310 may include nonvolatile memory circuitry programmed with system instructions to, when executed, cause the computer circuitry 320 to detect the presence of the iterative heartbeat communication, and in response to the iterative heartbeat communication being interrupted or otherwise not iterating, reinstall the application. For instance, instructions for installing the application may be stored in the memory circuitry when the computer circuitry is started, when the application is installed in the memory circuity, or both.

The system instructions may include a variety of instructions or combinations of instructions, which facilitate operation of the computer circuitry to carry out a variety of functions. In a particular example, the system instructions on the CRM 310, when executed, cause the computer circuitry 320 to create an entry in a table that identifies a device corresponding to the application. In response to the iterative communication not iterating, an output is generated to indicate that the device is present, which in turn causes the computer circuitry to access and execute instructions corresponding to the entry in the table. Such an approach may simulate, for example, a plug-and-play type device in which the application is characterized as a driver for such a device, and related code for installing the application is executed by the computer circuitry as if a driver for a device corresponding to the table entry is being installed.

In another example, the system instructions on the CRM 310 include instructions that, when executed, cause the computer circuitry 320 to create a table entry that identifies a device in response to an application being installed. An application package is created and stored, which includes instructions and data for installing the application, and the application is registered as a driver with an identification that matches the entry in the table. When the iterative communication is not detected at an expected iteration, an output is generated to indicate that the device is present. This causes the computer circuitry 320 to access and execute the instructions in the application package as a driver installation for the device. In some implementations, the entry is thereafter removed from the table or modified, such as to indicate that the device is not present.

In some implementations, the CRM 310 is programmed with system instructions that, when executed, cause the computer circuitry to store table data indicative of an installed device corresponding to the application and reinstall the application in response to an indication that the installed device is present. Table data indicating that the device is installed is removed after causing the computer circuitry to reinstall the application.

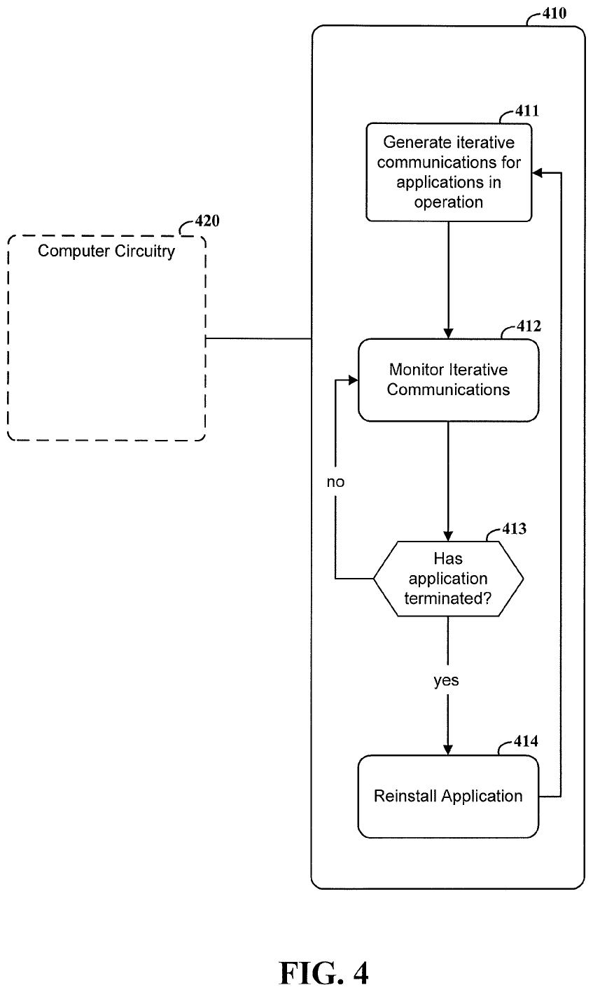

FIG. 4 is a diagram illustrating an example non-transitory CRM 410 with stored instructions (as may be executed by computer circuitry 420) for reinstalling applications that have terminated, in accordance with the present disclosure. At block 411, iterative communications are generated for applications that are in operation. This may involve, for example, generating iterative communications as part of operating each application, such as by executing instructions that are part of the application execution instructions, and which may identify the application via which the communications are generated. The iterative communications are monitored at block 412. Termination of one of the applications is identified at block 413, based on persistence characteristics of the iterative communications, and the one of the applications is reinstalled at block 414 in response to identifying that one of the applications has terminated operation. Such persistence characteristics may include, for example, an expected cyclical or non-cyclical series of the iterative communications, or lack of such a communication at an expected time and which indicates termination of the application via which the expected series of communications had been generated.

The following examples characterized in the context of FIG. 4 may be implemented independent of FIG. 4, with other figures, or with a combination of figures and other approaches. In some examples, instructions as may be implemented on the CRM 410 are to, in response to one of the applications being executed on the computer circuitry, cause the computer circuitry 420 to create an entry in a table that identifies devices, the entry corresponding to the one of the applications. In response to the persistence characteristics of the iterative communications generated for the one of the applications indicating that the iterative communications have ceased, the computer circuitry 420 generates an output that indicates that a device for the entry in the table is present, therein further causing the computer circuitry to access and execute instructions corresponding to the entry in the table. For instance, the output may be generated as part of the execution of BIOS or UEFI instructions on a non-volatile portion of the CRM 410, which causes another application being executed on the computer circuitry 420 to access and execute the instructions.

In another example, the CRM 410 includes instructions that, when executed by the computer circuitry 420, cause the computer circuitry to create an entry in a table having a plurality of entries that identify devices, create and store an application package including the instructions and data for installing the one of the applications, and register the one of the applications as a driver with an identification that matches the entry in the table. The instructions further cause the computer circuitry 420 to, in response to the iterative communications for the one of the applications ceasing, generate an output that indicates that the device is present, therein causing the computer circuitry to access and execute the instructions in the application package as a driver installation for the device. In some examples, the CRM 410 includes non-volatile memory and volatile memory, and the instructions that cause the computer circuitry to monitor the iterative communications, to identify that one of the applications has terminated operation, and reinstall the application are all stored in the non-volatile memory.

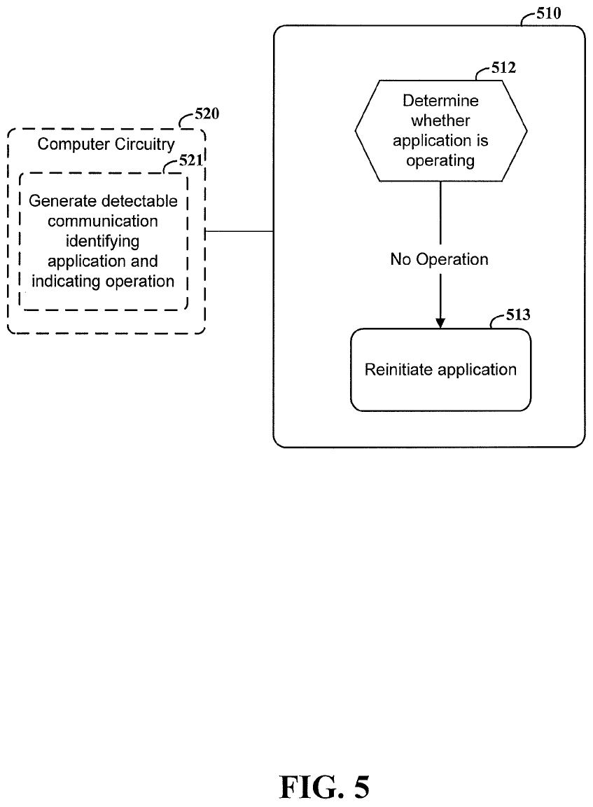

FIG. 5 is a diagram illustrating an example CRM 510 with stored instructions for monitoring application operation and reinitiating applications that have ceased operation. The instructions may be executed, for example, on computer circuitry 520 for carrying out the indicated operations. At block 510, a detectable communication is generated for identifying an application and indicating that the application is operating. If it is determined that the application is inactive/not operating at block 512, the application is re-initiated at block 513, such as by repairing, restarting or reinstalling the application. In some examples, the CRM 510 stores instructions that, when executed, cause the computer circuitry 520 to create and store a package including a copy of the application and a script that includes instructions for installing the application, register the package as a driver, and install the new version of the application by executing the script for installing the copy of the application.

The following embodiments may be implemented in connection one of more of the figures, in manners that may use other approaches not shown in the figures, or in a combination of manners with some aspects as depicted in a particular one of figures and other aspects as depicted in other figures or otherwise.

In some instances, an application is persisted on a computer operating system (OS) and generates iterative secure communications to computer firmware. The computer firmware may be implemented using BIOS or UEFI. A device entry may be made in an OS table that records devices, with supporting computer-readable instructions for the device being installed via a setup script. For instance, when the iterative communication fails, the BIOS or UEFI may indicate to the OS that the device is now present, in response to which the OS looks for a preinstalled package that contains information including an installation script related to the persisted application that should be running. The OS runs the installation script, which reinstalls and runs the application.

Various approaches may be carried out by using a hardware-based event to detect that the application is no longer running and needs to be reinstalled, and to further cause the application to run again. Such an event may involve monitoring operation of the application within an OS, and reinjecting the application in response to the monitoring indicating that the application is no longer operating. For instance, the application may generate an iterative communication while the application operates, and system hardware may monitor for the presence of the iterative communication. If the iterative communication is not detected when it would otherwise be expected, failure of the application to operate is detected in hardware and the application is re-installed. This may involve, for example, monitoring for the iterative communication in computer BIOS or UEFI, and causing the application to be reinstalled via instructions generated by the BIOS or UEFI.

Some examples are directed to an application, such as a service, that may be designed to run at computer startup and remain operational while the computer is operational, such as antivirus, firewalls and other security-related components. Such an application may execute secure communications with the BIOS or UEFI, and periodically send an iterative communication to the BIOS or UEFI to indicate that the application is running. The iterative communication may be a heartbeat-like communication, which repeats in a cyclic manner to indicate that the application is still operating. Absence of the heartbeat-like communication can be used as an indication that the application is no longer running.

In certain examples, an application has necessary components to perform a plug-and-play driver installation. When the application starts running, for instance upon installation or system startup, the application may create a copy of itself and uses OS infrastructure to register itself as a driver, along with the components for performing the plug-and-play driver installation. The application may also direct a driver to install a new application from another source. The OS may create a package of the application and driver components, store the package in a driver repository, and register the package as a resource package with an identification (ID) that matches an entry in a related table that stores information indicative of installed applications.

In some instances, the table stores data for allowing the OS to discover and configure hardware components, such as an ACPI (advanced configuration and power interface) table. The package created by the OS may contain a script that determines steps and function necessary to have the application running, such as those involving command parameters, folder creation, folder and file permission configuration, and a list of associated files. When the BIOS or UEFI detects that an iterative communication is missing, it may indicate to the OS that whatever device corresponding to the heartbeat defined in the table is now present. The device may have the same ID as is used in the application driver package noted above, and this ID can be used by the OS to seek driver components in a driver repository. Once the OS finds a package that matches the ID, it runs the installation using the script in the package. As the application is part of the package, the OS performs the installation and runs the application. The application then reestablishes a secure connection with the BIOS or UEFI and begins to generate the iterative communication again. The BIOS or UEFI may then remove the device from the ACPI table.

Timing of the iterative communications can be set based on a desired monitoring approach and associated timing efforts. For example, the timing may be based on an assumed significance of a particular application and related tradeoff relative to power and computational resources needed to carry out the iterative communication. Applications deemed to be of high significance, such as security-related applications, may generate a heartbeat-like communication that is iterated at a relatively high rate such that their failure to operate may be detected immediately. Applications deemed to be of relatively lower significance, for example as may relate to an ancillary function, may involve a lower rate of iteration.

Various examples herein characterized as being implemented as instructions stored on a non-transitory CRM, may be carried out as an apparatus including computer circuitry with memory circuitry including nonvolatile memory circuitry. The computer circuitry is to execute OS instructions to operate an application installed in memory circuitry, including generating an iterative heartbeat communication to indicate that the application is operating. The iterative communication may, for example, include data that identifies the application installed in memory, and may be generated on a cyclic basis. The nonvolatile memory circuitry is programmed with system instructions to, when executed, cause the computer circuitry to detect the presence of the iterative heartbeat communication, and in response to the iterative heartbeat communication not iterating, reinstall the application. For instance, instructions for installing the application may be stored in the memory circuitry when the computer circuitry is started, when the application is installed in the memory circuity, or both.

In the description herein, various specific details are set forth to describe specific examples. However, other examples and/or variations of these examples may be practiced without all the given details. In other instances, features have not been described in detail so as not to obscure the description of the examples herein. For instance, a variety of computer operating systems, hardware, BIOS or UEFI functions, and memory types may be utilized in connection with examples characterized herein. In addition, although aspects and features may be described in individual figures in some cases, features from one figure or example may be combined with features of another figure or example even though the combination is not explicitly shown or explicitly described as a combination. For instance, various method-based aspects may be implemented in connection with the apparatus depicted in FIG. 1. As another example, various circuit blocks or modules as characterized in the figures may be combined into a common circuit, or implemented with separate circuitry.

What is claimed is:

1. A non-transitory computer-readable medium (CRM) having instructions stored therein that, in response to being executed on computer circuitry, cause the computer circuitry to:
operate an application installed in the CRM to generate an iterative communication to indicate that the application is operating;
detect the presence of the iterative communication; and
in response to an interruption in the iterative communication, reinstall the application.

2. The non-transitory computer-readable medium of claim 1, wherein the instructions include instructions that, when executed, cause the computer circuitry to:
create an entry in a table that identifies a device corresponding to the application, and in response to interruption of the iterative communication, generate an output that indicates that the device is present, and access and execute instructions corresponding to the entry in the table.

3. The non-transitory computer-readable medium of claim 1, wherein the instructions include instructions that, when executed, cause the computer circuitry to:
in response to the application being installed, create an entry in a table that identifies a device, create and store an application package including the instructions and data for installing the application, and register the application as a driver with an identification that matches the entry in the table; and
in response to interruption of the iterative communication, generate an output that indicates that the device is present, therein causing the computer circuitry to access and execute the instructions in the application package as a driver installation for the device.

4. The non-transitory computer-readable medium of claim 3, wherein the instructions include instructions that, when executed, cause the computer circuitry to remove the entry from the table.

5. The non-transitory computer-readable medium of claim 3, wherein the instructions include instructions that, when executed, cause the computer circuitry to modify the entry in the table to indicate that the device is not present.

6. The non-transitory computer-readable medium of claim 1, wherein the instructions include instructions that, when executed, cause the computer circuitry to:
store table data indicative of an installed device corresponding to the application;
reinstall the application in response to an indication that the installed device is present; and
after causing the computer circuitry to reinstall the application, remove the table data indicating that the device is installed.

7. The non-transitory computer-readable medium of claim 1, wherein the instructions include instructions that, when executed, cause the computer circuitry to store the instructions for installing the application in memory circuitry in response to startup of the computer circuitry.

8. The non-transitory computer-readable medium of claim 1, wherein the instructions include instructions that, when executed, cause the computer circuitry to write instructions for installing applications in memory circuitry in response to the applications being installed in the memory circuity.

9. A non-transitory computer-readable medium having instructions stored therein that, in response to being executed on computer circuitry, cause the computer circuitry to:
generate an iterative communication to indicate that an application is operating;
monitor the iterative communication generated for the application;
identify that the application has terminated operation based on persistence characteristics of the monitored iterative communication; and
in response to identifying that the application has terminated operation, reinstall the application.

10. The non-transitory computer-readable medium of claim 9, wherein the instructions are to, in response to the instructions and the application being executed on the computer circuitry, cause the computer circuitry to:
create an entry in a table that identifies devices, the entry corresponding to the application, and
in response to the persistence characteristics of the iterative communication generated for the application indicating that the iterative communications have ceased, generate an output that indicates that a device for the entry in the table is present, therein causing the computer circuitry to access and execute instructions corresponding to the entry in the table.

11. The non-transitory computer-readable medium of claim 9, wherein the instructions cause, in response to being executed on the computer circuitry and to the application being installed, the computer circuitry to
create an entry in a table having a plurality of entries that identify devices, create and store an application package including the instructions and data for installing the application, and register the application as a driver with an identification that matches the entry in the table; and
in response to the iterative communication for the application ceasing, generate an output that indicates that the device is present, therein causing the computer circuitry to access and execute the instructions in the application package as a driver installation for the device.

12. The non-transitory computer-readable medium of claim 9, wherein the non-transitory computer-readable medium includes non-volatile memory and volatile memory, and wherein the instructions that cause the computer circuitry to monitor the iterative communication, to identify that the application has terminated operation, and that reinstall the application, are stored in the non-volatile memory.

13. A non-transitory computer-readable medium (CRM) having instructions stored therein that cause, in response to being executed on computer circuitry, the computer circuitry to:
determine whether an application is being operated by the computer circuitry, based on the generation of a detectable communication as part of the application operation, the detectable communication identifying the application and indicating that the application is operating; and
in response to determining that the application is inactive, reinitiate operation of the application.

14. The non-transitory computer-readable medium of claim 13, wherein the instructions are to reinitiate the operation of the application by causing the computer circuitry to install a new version of the application and to initiate operation of the new version of the application.

15. The non-transitory computer-readable medium of claim 14, wherein the instructions are to, in response to being executed on the computer circuitry, cause the computer circuitry to:
create and store a package including a copy of the application and a script that includes instructions for installing the application;
register the package as a driver; and
install the new version of the application by executing the script for installing the copy of the application.
